(19) United States
(12) Patent Application Publication
(10) Pub. No.: US 2026/0361981 A1
(43) Pub. Date: Nov. 12, 2026

(54) BLUR CORRECTION DEVICE AND IMAGING DEVICE

(71) Applicant: SONY GROUP CORPORATION, TOKYO (JP)

(72) Inventors: ATSUSHI TANI, TOKYO (JP); HIROSHI ABE, TOKYO (JP)

(21) Appl. No.: 19/153,494

(22) PCT Filed: Jan. 30, 2024
(86) PCT No.: PCT/JP2024/002748

§ 371 Date: Aug. 4, 2025

(30) Foreign Application Priority Data
Feb. 21, 2023 (JP) 2023-024996

(51) Int. Cl. H04N 23/52; H04N 23/51; H04N 23/68

(52) U.S. Cl. CPC H04N 23/52; H04N 23/51; H04N 23/687

(57) ABSTRACT

A blur correction device includes a fixed body fixed inside a housing, a movable body having an imaging element and moved in a direction orthogonal to an optical axis direction with respect to the fixed body, and an elastically deformable heat transfer sheet provided as a first close contact portion partially in close contact with the movable body in a state of being in surface contact with the movable body and a second close contact portion partially in close contact with the housing in a state of being in surface contact with the housing. A third close contact portion in close contact with the fixed body in a state of being in surface contact with the fixed body is provided between the first close contact portion and the second close contact portion of the heat transfer sheet, and in the heat transfer sheet, a first bent portion is provided between the first close contact portion and the third close contact portion, and a second bent portion is provided between the third close contact portion and the second close contact portion.

### TECHNICAL FIELD

The present technology relates to a technical field of a blur correction device in which a movable body having an imaging element is movable in a direction orthogonal to an optical axis direction with respect to a fixed body, and an imaging device including the blur correction device.

### BACKGROUND ART

A blur correction device for correcting camera shake generated at the time of imaging and the like to improve image quality is provided in some imaging devices such as a video camera and a still camera (see, for example, Patent Document 1).

When such a blur correction device includes an imaging element in the movable body, there is a possibility that heat is generated from the imaging element, a circuit board, and the like when the imaging device is driven and the generated heat affects driving of the imaging element or affects a stable driving state of the circuit board.

In the imaging device described in Patent Document 1, a configuration in which a part of a heat transfer member (heat dissipation member) having flexibility is attached to the imaging element and heat generated in the imaging element and the like is transmitted to a housing is illustrated.

### CITATION LIST

### Patent Document

Patent Document 1: Japanese Patent Application Laid-Open No. 2010-205916

### SUMMARY OF THE INVENTION

### Problems to be Solved by the Invention

Incidentally, in the blur correction device, since the movable body is moved in the direction orthogonal to the optical axis with respect to the fixed body at the time of camera shake correction, it is necessary to ensure a smooth movement state of the movable body with respect to the fixed body by having a configuration in which the heat transfer member that transfers the heat generated in the imaging element and the like of the movable body not to hinder the movement of the movable body.

Furthermore, in the blur correction device, it is also necessary to improve transfer efficiency of the heat generated in the movable body to an outside to achieve a more stable driving state of the imaging element.

Therefore, an object of a blur correction device and an imaging device of the present technology is to improve transfer efficiency of heat generated in a movable body to an outside while securing a smooth movement state of the movable body with respect to a fixed body.

### Solutions to Problems

A blur correction device according to the present technology includes a fixed body fixed inside a housing, a movable body having an imaging element and moved in a direction orthogonal to an optical axis direction with respect to the fixed body, and an elastically deformable heat transfer sheet provided as a first close contact portion partially in close contact with the movable body in a state of being in surface contact with the movable body and a second close contact portion partially in close contact with the housing in a state of being in surface contact with the housing. A third close contact portion in close contact with the fixed body in a state of being in surface contact with the fixed body is provided between the first close contact portion and the second close contact portion of the heat transfer sheet, and in the heat transfer sheet, a first bent portion is provided between the first close contact portion and the third close contact portion, and a second bent portion is provided between the third close contact portion and the second close contact portion

Therefore, the elastically deformable heat transfer sheet is partially in close contact with the movable body, the fixed body, and the housing, and the first bent portion is deformed when the movable body moves with respect to the fixed body.

An imaging device according to the present technology includes a blur correction device in which a movable body having an imaging element is movable in a direction orthogonal to an optical axis direction with respect to a fixed body fixed inside a housing. The blur correction device includes an elastically deformable heat transfer sheet provided as a first close contact portion partially in close contact with the movable body in a state of being in surface contact with the movable body and a second close contact portion partially in close contact with the housing in a state of being in surface contact with the housing, a third close contact portion in close contact with the fixed body in a state of being in surface contact with the fixed body is provided between the first close contact portion and the second close contact portion of the heat transfer sheet, and in the heat transfer sheet, a first bent portion is provided between the first close contact portion and the third close contact portion, and a second bent portion is provided between the third close contact portion and the second close contact portion.

Therefore, in the blur correction device, the elastically deformable heat transfer sheet is partially in close contact with the movable body, the fixed body, and the housing, and the first bent portion is deformed when the movable body moves with respect to the fixed body.

### BRIEF DESCRIPTION OF DRAWINGS

FIG. 1 illustrates a blur correction device and an imaging device of the present technology together with FIGS. 2 to 10, and is a perspective view of the imaging device.

FIG. 2 is an exploded perspective view of the blur correction device.

FIG. 3 is a perspective view of the blur correction device.

FIG. 4 is a conceptual diagram illustrating a state of a heat transfer sheet.

FIG. 5 is a conceptual diagram illustrating an example in which the heat transfer sheet is in close contact with a rear surface portion of a housing.

FIG. 6 is a conceptual diagram illustrating an example in which the heat transfer sheet is in close contact with a side surface portion of the housing.

FIG. 7 is a conceptual diagram illustrating an example in which an annular portion is provided in the heat transfer sheet.

FIG. 8 is a conceptual diagram illustrating an example in which the heat transfer sheet is in close contact with two portions of the housing.

FIG. 9 is a diagram for describing an operation state of a movable body moved at the time of blur correction of the blur correction device.

FIG. 10 is a block diagram of the imaging device.

### MODE FOR CARRYING OUT THE INVENTION

Hereinafter, modes for carrying out a blur correction device and an imaging device of the present technology will be described with reference to the accompanying drawings.

In a mode for carrying out inventions to be described below, the imaging device of the present technology is applied to a still camera, and the blur correction device of the present technology is applied to a blur correction device provided in the still camera.

Note that, application ranges of the imaging device and the blur correction device of the present technology are not limited to the still camera and the blur correction device provided in the still camera, respectively. The imaging device and the blur correction device of the present technology can be widely applied to, for example, imaging devices incorporated in various electronic devices such as a video camera, a mobile phone, and a portable information terminal, or a blur correction device provided in the imaging devices thereof.

In the following description, it is assumed that front-rear, upper-lower, and left-right directions are indicated as directions viewed from a photographer at the time of imaging with the still camera. Accordingly, a subject side is the front, and a photographer side is the rear.

Note that, the front-rear, upper-lower, and left-right directions below are for the sake of convenience in description, and the implementation of the present technology is not limited to these directions.

Furthermore, the following lens includes both a lens constituted by a single lens and a lens group constituted by a plurality of lenses.

### Schematic Configuration of Imaging Device

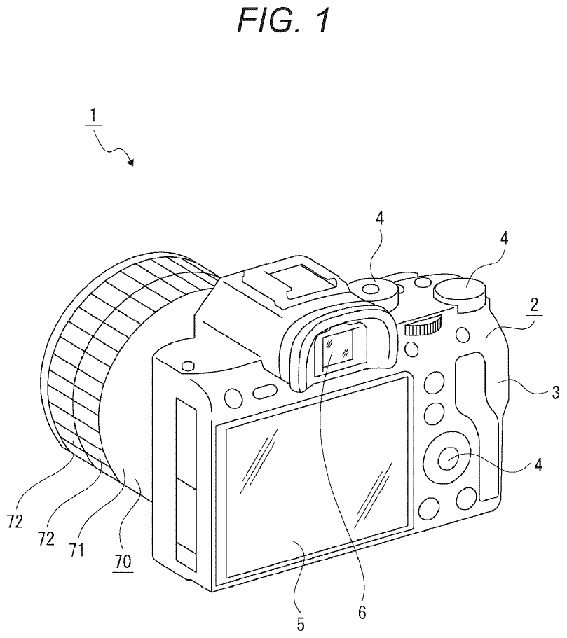

An imaging device 1 includes a device body 2, and the device body 2 is formed by disposing required portions inside and outside a housing 3 (see FIG. 1).

A light transmission opening (not illustrated) having a circular shape is formed on a front surface portion of the device body 2, and a portion around the light transmission opening is provided as a mount portion for attaching a lens barrel 70. A charge coupled device (CCD) or a complementary metal-oxide semiconductor (CMOS) is disposed as an imaging element as described later at the rear of the light transmission opening inside the device body 2.

In the device body 2, for example, various operation units 4 are disposed on an upper surface, a rear surface, and the like. For example, a power button, a shutter button, a zoom knob, a mode switching knob, and the like are provided as the operation units 4. A display 5 is disposed on the rear surface of the device body 2. A main board (control board) (not illustrated) is disposed inside the device body 2. A finder 6 is provided at an upper end portion of the device body 2.

The lens barrel 70 is, for example, an interchangeable lens detachable from the device body 2. Note that, the present technology can also be applied to a type in which a lens unit having a structure similar to an internal structure of the lens barrel 70 is incorporated inside the device body or a retractable type in which a lens unit protrudes or is accommodated with respect to the device body.

Note that, in the present technology, the imaging device 1 may be constituted only by the device body 2, or the imaging device 1 may be constituted by the device body 2 and the lens barrel 70.

The lens barrel 70 includes a substantially cylindrical outer barrel 71 whose axial direction is a front-rear direction, and required portions attached to or supported inside and outside the outer barrel 71. The axial direction of the lens barrel 70 coincides with an optical axis direction of the entire imaging device 1.

A rear end portion of the lens barrel is coupled to the mount portion by, for example, bayonet coupling, and thus, the lens barrel 70 is attached to the device body 2. For example, a plurality of operation rings 72 that function as a zoom ring and a focus ring are provided in the lens barrel 70. The operation ring 72 is rotatably supported by the outer barrel 71, and zooming and focusing are performed when the operation ring 72 is rotationally operated.

Inside the lens barrel 70, a plurality of lenses (not illustrated) are positioned to be separated from each other in the optical axis direction (front-rear direction), and these lenses include a movable lens (movable lens group) movable in the optical axis direction and a fixed lens (fixed lens group) immovable in the optical axis direction.

### Configuration of Blur Correction Device

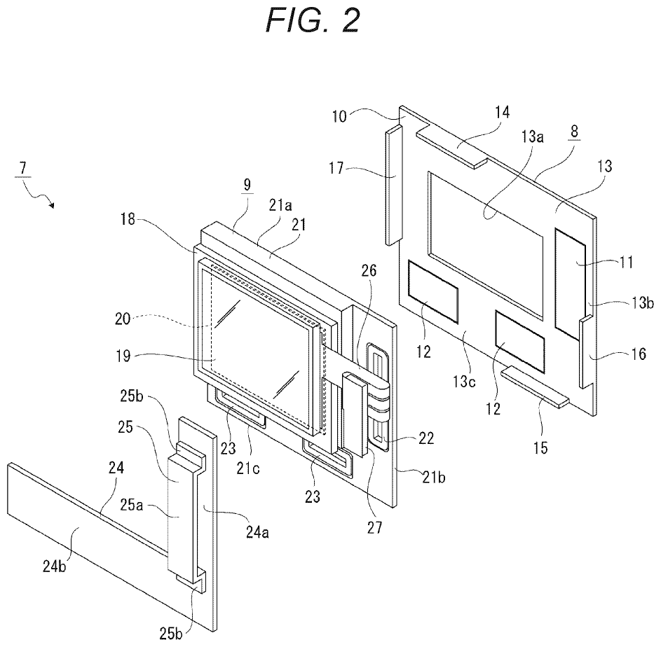

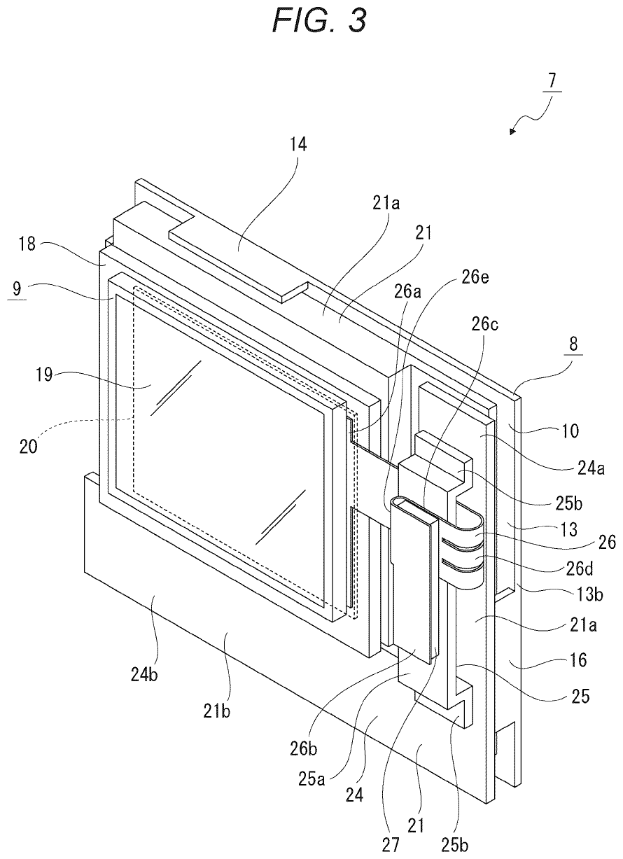

A blur correction device 7 that corrects camera shake is disposed inside the device body 2 (see FIGS. 2 and 3). The blur correction device 7 includes a fixed body 8 and a movable body 9. In the blur correction device 7, the movable body 9 is moved in a direction orthogonal to the optical axis direction with respect to the fixed body 8 to correct the camera shake.

The fixed body 8 includes a base plate 10, first magnets 11, and second magnets 12.

The base plate 10 includes a base portion 13 formed in a plate shape facing the front-rear direction, a first restricting portion 14 protruding forward from an upper end portion of the base portion 13, a second restricting portion 15 protruding forward from a lower end portion of the base portion 13, a third restricting portion 16 protruding forward from one side portion of the base portion 13, and a fourth restricting portion 17 protruding forward from the other side portion of the base portion 13.

An opening 13a penetrating in the front-rear direction is formed in the base portion 13. A side portion of the base portion 13 on a side where the third restricting portion 16 is provided is provided as a first magnet attachment portion 13b, and a lower portion of the base portion 13 is provided as a second magnet attachment portion 13c.

The first magnets 11 are formed in a vertically long shape, and two magnets are attached to the first magnet attachment portion 13b of the base plate 10 side by side in the left-right direction. The second magnets 12 are formed in a horizontally long shape, and two magnets are attached to the second magnet attachment portion 13c of the base plate 10 so as to be separated from each other in the left-right direction.

The movable body 9 is constituted by attaching or holding required portions to or in a holding base 18. The holding base 18 is formed in a substantially rectangular frame shape.

An imaging element 19 is attached to and held on a front surface of the holding base 18. For example, a charge coupled device (CCD), a complementary metal-oxide semiconductor (CMOS), and the like are used as the imaging element 19. Note that, a gap is formed at least partially between the front surface of the holding base 18 and an outer peripheral portion of a rear surface of the imaging element 19.

A circuit board 20 is attached to a rear surface of the holding base 18.

A frame 21 is attached to an outer peripheral portion of the rear surface of the holding base 18 in a state of covering the circuit board 20 from a periphery. The frame 21 includes a rectangular frame-shaped portion 21a, a first coil attachment portion 21b protruding laterally from the frame-shaped portion 21a, and a second coil attachment portion 21c protruding downward from the frame-shaped portion 21a.

A vertically long first coil 22 is attached to the first coil attachment portion 21b, and two horizontally long second coils 23 are attached to the second coil attachment portion 21c in a state of being separated in the left-right direction.

The movable body 9 having the above configuration is supported by the fixed body 8 on a front surface side of the base plate 10 so as to be movable in the direction orthogonal to the optical axis direction. In the movable body 9, the first coil 22 and the second coils 23 are positioned to face the first magnet 11 and the second magnets 12 of the fixed body 8, respectively. The first coil 22 and the first magnet 11 constitute a first drive unit, and the second coil 23 and the second magnet 12 constitute a second drive unit.

In each of the first drive unit and the second drive unit, a magnetic force is generated, and the movable body 9 is attracted toward the fixed body 8 by the generated magnetic force and is held by the fixed body 8.

The movable body 9 is movable (rotatable) in a rotation direction (roll direction) around an optical axis, which is the left-right direction, the upper-lower direction, and a direction around the optical axis, with respect to the fixed body 8 by driving forces of the first drive unit and the second drive unit. The optical axis is an axis passing through a center of the imaging element 19 and extending in the front-rear direction.

When a current is supplied to the first coil 22, the movable body 9 is moved in the left-right direction with respect to the fixed body 8 in relationship to a magnetic field generated by the first magnet 11, and when a current is supplied to the second coil 23, the movable body 9 is moved in the upper-lower direction with respect to the fixed body 8 in relationship to a magnetic field generated by the second magnet 12. Furthermore, when a current is supplied to the two second coils 23 in a reverse direction, an upward thrust is generated by the one second coil 23 and the one second magnet 12, a downward thrust is generated by the other second coil 23 and the other second magnet 12, and the movable body 9 is rotated in the direction around the optical axis with respect to the fixed body 8. Accordingly, the movable body 9 is movable in any direction in a plane orthogonal to the optical axis direction with respect to the fixed body 8.

In a state where the movable body 9 is supported by the fixed body 8, the entire movable body 9 is positioned in a region surrounded by the first restricting portion 14, the second restricting portion 15, the third restricting portion 16, and the fourth restricting portion 17 of the base plate 10, and movement (rotation) of the movable body 9 in the direction orthogonal to the optical axis direction is restricted by the first restricting portion 14, the second restricting portion 15, the third restricting portion 16, and the fourth restricting portion 17. Accordingly, the first restricting portion 14, the second restricting portion 15, the third restricting portion 16, and the fourth restricting portion 17 function as movement restricting portions called so-called mechanical ends that restrict excessive movement (rotation) of the movable body 9 with respect to the fixed body 8.

Note that, any shapes and sizes of the first restricting portion 14, the second restricting portion 15, the third restricting portion 16, and the fourth restricting portion 17 are used, and may be formed in a plate shape or may be formed in a shaft shape, for example.

In a state where the movable body 9 is supported by the fixed body 8, a pressing plate 24 is attached to the base plate 10 from a front side by screwing and the like, and a sheet attachment member 25 is attached to a front surface of the pressing plate 24. For example, the pressing plate 24 may be attached to the base plate 10 by providing a plurality of screwing bosses protruding forward on the base plate 10, or may be attached to the base plate 10 by being bonded to the first restricting portion 14 and the like.

The pressing plate 24 and the sheet attachment member 25 are provided as a part of the fixed body 8.

The pressing plate 24 is formed in a substantially L shape by a vertically long portion 24a extending in the upper-lower direction and a horizontally long portion 24b extending in the left-right direction. In a state where the pressing plate 24 is attached to the base plate 10, the first coil 22 is closed from the front side by the vertically long portion 24a, and the second coil 23 is closed from the front side by the horizontally long portion 24b.

The sheet attachment member 25 includes a flat plate-shaped attachment portion 25a facing the front-rear direction and a pair of attached leg portions 25b protruding rearward from upper and lower end portions of the attachment portion 25a. In the sheet attachment member 25, the attached leg portion 25b is attached to the vertically long portion 24a, and a space is formed between the attachment portion 25a and the vertically long portion 24a in a state where the sheet attachment member 25 is attached to the pressing plate 24.

The pressing plate 24 is attached to the base plate 10 from the front side, and thus, the movable body 9 is prevented from falling off to the front side with respect to the fixed body 8.

A heat transfer sheet 26 is partially in close contact with the movable body 9 and the housing 3 (see FIGS. 3 and 4). For example, a graphite sheet is used as the heat transfer sheet 26. One end portion of the heat transfer sheet 26 is provided as a first close contact portion 26a, the other end portion is provided as a second close contact portion 26b, and a part of an intermediate portion in a longitudinal direction is provided as a third close contact portion 26c. The first close contact portion 26a, the third close contact portion 26c, and the second close contact portion 26b are positioned to be separated from each other in the longitudinal direction of the heat transfer sheet 26.

The heat transfer sheet 26 is in close contact with the rear surface of the imaging element 19 in a state where the first close contact portion 26a is inserted into the gap between the front surface of the holding base 18 and the rear surface of the imaging element 19, the second close contact portion 26b is in close contact with an inner surface of the housing 3, for example, a front surface portion, and the third close contact portion 26c in the longitudinal direction is in close contact with a front surface of the attachment portion 25a of the sheet attachment member 25 in a state of being in surface contact (see FIG. 4). Accordingly, heat generated in the movable body 9 is transferred to the housing 3 by the heat transfer sheet 26.

Note that, the first close contact portion 26a of the heat transfer sheet 26 may be in close contact with both the imaging element 19 and the circuit board 20. Furthermore, the heat transfer sheet 26 is not limited to the graphite sheet, and may be another member having thermal conductivity and flexibility (elasticity). For example, the heat transfer sheet may be a metal foil such as a copper foil or a flexible printed wiring board. In a case where the flexible printed wiring board is used as the heat transfer sheet 26, since the heat transfer sheet 26 can be used as a wiring and can be used as a member that performs heat conduction, it is not necessary to provide another wiring for the imaging element 19, and it is possible to reduce manufacturing cost by reducing the number of components in the imaging device 1.

However, the graphite sheet is used as the heat transfer sheet 26, and thus, graphite is a material which is lightweight and has excellent flexibility and thermal conductivity. As a result, heat transfer efficiency from the movable body 9 to the housing 3 can be improved and a load applied to the movable body 9 from the heat transfer sheet 26 can be reduced.

In the heat transfer sheet 26, a first bent portion 26d is provided between the first close contact portion 26a and the third close contact portion 26c, and a second bent portion 26e is provided between the second close contact portion 26b and the third close contact portion 26c. The first bent portion 26d and the second bent portion 26 e are folded back by 180 degrees, and folded-back directions are opposite to each other. Note that, the first bent portion 26d and the second bent portion 26e may be in a state of being easily bent by forming a slit.

An elastic body 27 is disposed between the third close contact portion 26c and the second close contact portion 26b of the heat transfer sheet 26. For example, a cushion material such as sponge is used as the elastic body 27. One surface of the elastic body 27 is in close contact with the second close contact portion 26b, the other surface is in close contact with the third close contact portion 26c, the second close contact portion 26b is pressed against the inner surface of the housing 3 by elasticity of the elastic body 27 to be in close contact, and the third close contact portion 26c is pressed against a front surface of the sheet attachment member 25 by the elasticity of the elastic body 27 to be in close contact.

Note that, for example, a leaf spring or a member including silicon may be used as the elastic body 27. Since the elastic body 27 includes a material having thermal conductivity by using the leaf spring or the member including silicon as the elastic body 27, it is possible to improve the transfer efficiency of the heat in which at least a part of the heat transferred from the movable body 9 by the heat transfer sheet 26 is transferred from the elastic body 27 to the housing 3 and transferred from the movable body 9 to the housing 3 by the heat transfer sheet 26.

However, the cushion material such as sponge is used as the elastic body 27, and thus, the elastic body 27 becomes inexpensive. As a result, the manufacturing cost of the imaging device 1 can be reduced.

The first close contact portion 26a of the heat transfer sheet 26 is, for example, in close contact with the rear surface of the imaging element 19 in a state of being pressed by the pressing portion 28. The pressing portion 28 is provided, for example, as a part of portions disposed inside the housing 3.

The first close contact portion 26a is pressed by the pressing portion 28 via the elastic body 29, for example. Members and materials similar to those of the elastic body 27 are used as the elastic body 29. However, the elastic body 29 may not be present between the first close contact portion 26a and the pressing portion 28, and the first close contact portion 26a may be pressed by the pressing portion 28 in a state where the pressing portion 28 is in close contact with the first close contact portion 26a.

In the imaging device 1, a position of the fixed body 8 in the optical axis direction (front-rear direction) inside the housing 3 can be adjusted, and a position of the fixed body 8 in the front-rear direction with respect to the housing 3 is adjusted to adjust a focal position of light incident on the imaging element 19. The position adjustment of the fixed body 8 is performed when each portion is assembled in the blur correction device 7.

At this time, a position of the third close contact portion 26c in close contact with the sheet attachment member 25 in the front-rear direction is changed with the position adjustment of the fixed body 8, but since the second bent portion 26e is provided between the second close contact portion 26b and the third close contact portion 26c in the heat transfer sheet 26, a degree of bending of the second bent portion 26e is changed with a change in the position of the third close contact portion 26c in the front-rear direction. Accordingly, an unnecessary load is not applied from the heat transfer sheet 26 to the fixed body 8 and the housing 3, and a stable disposition state of the fixed body 8 is secured. The fixed body 8 is fixed at an adjusted position with respect to the housing 3 after the position adjustment is completed.

Furthermore, when the position of the third close contact portion 26c in the front-rear direction is changed in the position adjustment of the fixed body 8, a degree of bending of the first bent portion 26d is also changed with the change in the position of the third close contact portion 26c in the front-rear direction. Accordingly, an unnecessary load is not applied from the heat transfer sheet 26 to the movable body 9.

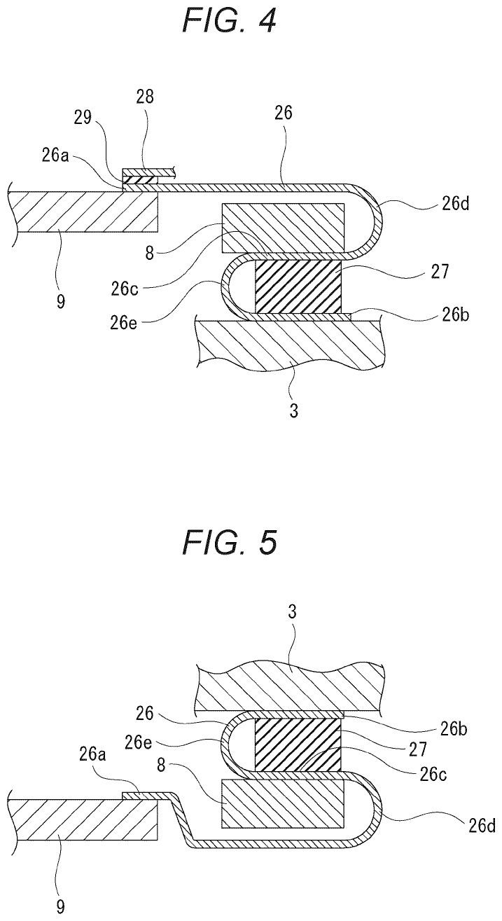

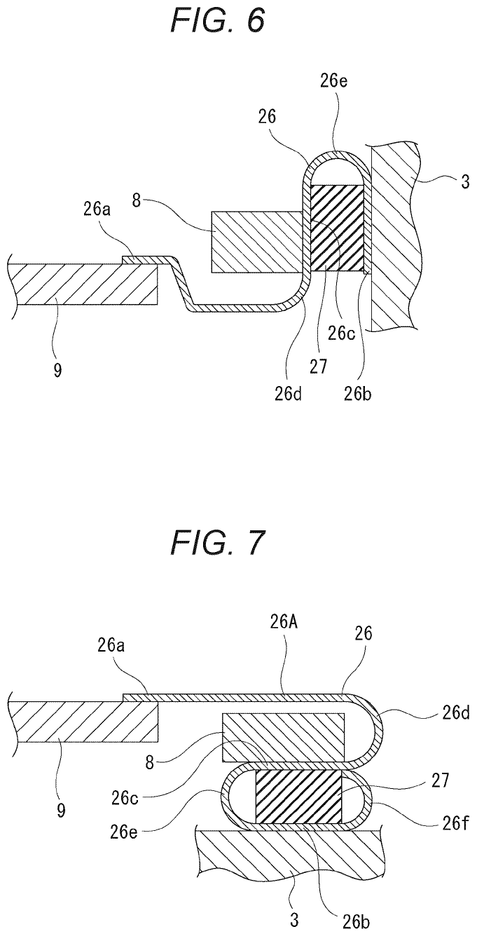

Note that, in the above description, an example in which the second close contact portion 26b of the heat transfer sheet 26 is in close contact with the inner surface of the front surface portion of the housing 3 has been described. However, depending on a configuration of the blur correction device 7 and a positional relationship between the portions, the second close contact portion 26b may be in close contact with an inner surface of a rear surface portion of the housing 3 (see FIG. 5), and the second close contact portion 26b may be in close contact with an inner surface of a side surface portion of the housing 3 (see FIG. 6).

### Operation in Imaging Device

In the imaging device 1 having the above configuration, in a state where power is turned on at the time of imaging and the like, the imaging element 19 is in a driving state, and heat is generated from the movable body 9, particularly, the imaging element 19 and the circuit board 20. The heat generated in the movable body 9 is transferred to the housing 3 by the heat transfer sheet 26, and is released from the housing 3 to an outside. At this time, in the heat transfer sheet 26, the first close contact portion 26a and the second close contact portion 26b are in close contact with surfaces of the movable body 9 and the housing 3 in a state of being in surface contact with each other, and the first close contact portion 26a and the second close contact portion 26b are not attached to the surfaces by a double-sided tape and the like. Thus, a loss of heat transfer performance due to contact resistance is small, and high transfer efficiency of the heat to the housing 3 is secured.

Accordingly, a temperature rise of the movable body 9, particularly, the imaging element 19 and the circuit board 20 is suppressed, and a favorable driving state of the imaging element 19, the circuit board 20, and the like is secured.

At the time of imaging and the like described above, a blur correction operation is performed by moving the movable body 9 in the direction orthogonal to the optical axis direction with respect to the fixed body 8. In the blur correction operation, force is applied to the heat transfer sheet 26 along with the movement of the movable body 9 with respect to the fixed body 8. However, since the first bent portion 26d is provided between the first close contact portion 26a and the third close contact portion 26c in the heat transfer sheet 26, the first bent portion 26d is deformed along with the movement of the movable body 9 with respect to the fixed body 8, and the force applied to the heat transfer sheet 26 is absorbed.

Accordingly, an unnecessary load is not applied from the heat transfer sheet 26 to the movable body 9, the movable body 9 is smoothly moved, and the blur correction operation is smoothly and quickly performed.

### Conclusion

As described above, in the blur correction device 7 and the imaging device 1 including the blur correction device 7, the heat transfer sheet 26 having the first close contact portion 26a, the second close contact portion 26b, and the third close contact portion 26c that are in close contact with the movable body 9, the housing 3, and the fixed body 8 in a state of being in surface contact with each other is provided, the first bent portion 26d is provided between the first close contact portion 26a and the third close contact portion 26c, and the second bent portion 26e is provided between the third close contact portion 26c and the second close contact portion 26b.

Accordingly, since the elastically deformable heat transfer sheet 26 is partially in close contact with the movable body 9, the fixed body 8, and the housing 3 and the first bent portion 26d is deformed when the movable body 9 moves with respect to the fixed body 8, it is possible to improve the transfer efficiency of the heat generated in the movable body 9 to the outside while securing a smooth moving state of the movable body 9 with respect to the fixed body 8.

Furthermore, the elastic body 27 is disposed between the second close contact portion 26b and the third close contact portion 26c, and the second close contact portion 26b is pressed against the housing 3 and the third close contact portion 26c is pressed against the fixed body 8 by the elasticity of the elastic body 27.

Accordingly, since there is no member and the like that hinder heat conduction such as an adhesive between the heat transfer sheet 26 and the housing 3 and between the heat transfer sheet 26 and the fixed body 8, it is possible to improve the transfer efficiency of the heat of the heat transferred from the movable body 9 to the housing 3 by the heat transfer sheet 26.

Furthermore, since the elastic body 27 is disposed between the housing 3 and the fixed body 8, even in a case where the fixed body 8 is inclined with respect to the housing 3 or the fixed body 8 and the housing 3 have unevenness, the elastic body 27 is deformed following the inclination or the unevenness, and high adhesion of the second close contact portion 26b to the housing 3 and high adhesion of the third close contact portion 26c to the fixed body 8 can be secured. As a result, a degree of freedom in design can be improved while high heat transfer performance is secured.

Moreover, the second close contact portion 26b and the third close contact portion 26c are in close contact with the housing 3 and the fixed body 8, respectively, without performing an adhesion work and the like. Accordingly, even in a case where the housing 3 and the fixed body 8 are in a positional relationship in which it is difficult to perform an adhesion work and the like such that the housing 3 and the fixed body 8 are aligned in the front-rear direction, for example, it is possible to ensure high adhesion of the second close contact portion 26b to the housing 3 and high adhesion of the third close contact portion 26c to the fixed body 8, and it is possible to reduce the size and improve the degree of freedom in design.

Note that, in the above description, an example in which the first close contact portion 26a is pressed against the movable body 9 by the pressing portion 28 and the second close contact portion 26b and the third close contact portion 26c are pressed against the housing 3 and the fixed body 8 by the elasticity of the elastic body 27, respectively, has been described. However, the first close contact portion 26a, the second close contact portion 26b, and the third close contact portion 26c may be bonded to the movable body 9, the housing 3, and the fixed body 8, respectively, by, for example, a double-sided tape and the like.

### Another Configuration of Heat Transfer Sheet

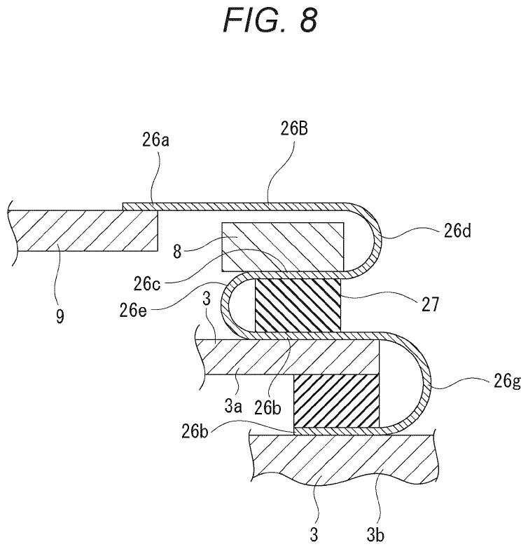

Hereinafter, a heat transfer sheet 26A (see FIG. 7) and a heat transfer sheet 26B (see FIG. 8) according to another configuration of the heat transfer sheet will be described.

In the heat transfer sheet 26A, a third bent portion 26f is provided between the second close contact portion 26b and the third close contact portion 26c in addition to the second bent portion 26e, and a portion having the second close contact portion 26b, the third close contact portion 26c, the second bent portion 26e, and the third bent portion 26f is formed an annular shape.

The heat transfer sheet 26A is used, and thus, a heat transfer path passing through the third bent portion 26f is formed between the housing 3 and the fixed body 8 in addition to a heat transfer path passing through the second bent portion 26e. As a result, it is possible to further improve the transfer efficiency of the heat to be transferred from the movable body 9 to the housing 3 by the heat transfer sheet 26A.

Furthermore, since the annular portion is provided in the heat transfer sheet 26A, it is easy to handle the heat transfer sheet 26A at the time of assembling the fixed body 8 and the movable body 9 to the inside of the housing 3, and workability in assembling each portion and the like can be improved.

Note that, similarly to the heat transfer sheet 26, in the heat transfer sheet 26A, the second close contact portion 26b may also be in close contact with any inner surface of the front surface portion, the rear surface portion, or the side surface portion of the housing 3. Furthermore, the portion formed in the annular shape may be in a state where the heat transfer sheet 26A is wound multiple times such as double or triple.

In the heat transfer sheet 26B, a continuously extended portion is provided at a distal end of the second close contact portion 26b, and the third bent portion 26g and the second close contact portion 26b are sequentially provided in the extended portion. Accordingly, two second close contact portions 26b are provided in the heat transfer sheet 26B.

In the heat transfer sheet 26B, the two second close contact portions 26b are in close contact with surfaces of different portions 3a and 3b of the housing 3 in a state of being in surface contact with each other. The elastic body 27 is also disposed in a portion between the portion 3a and the second close contact portion 26b on the distal end side, the elastic body 27 is pressed against and in close contact with the portion 3a of the housing 3, and the second close contact portion 26b is pressed against and in close contact with the portion 3b of the housing 3 by the elasticity of the elastic body 27.

Note that, similarly to the heat transfer sheet 26, in the heat transfer sheet 26B, the second close contact portion 26b may also be in close contact with any surface of the front surface portion, the rear surface portion, or the side surface portion of the housing 3. Furthermore, similarly to the heat transfer sheet 26A, an annular portion may be provided in the heat transfer sheet 26B.

The heat transfer sheet 26B is used, and thus, the plurality of second close contact portions 26b are in close contact with the different portions of the housing 3, respectively. As a result, the heat transferred from the movable body 9 by the heat transfer sheet 26B is released from the different portions of the housing 3, and release efficiency of the heat generated in the movable body 9 to the outside can be improved.

### Others

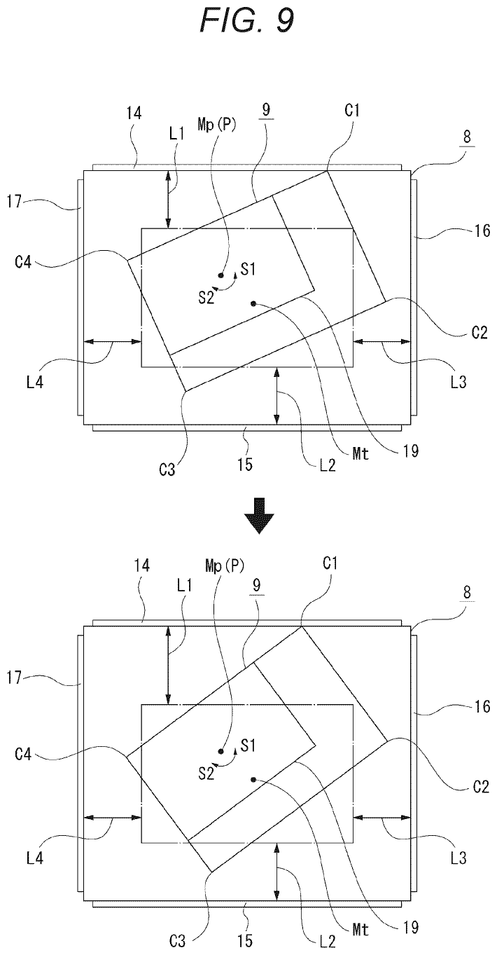

Hereinafter, an operation state of the movable body 9 moved at the time of blur correction of the blur correction device 7 will be described (see FIG. 9). Note that, the configuration to be described below is not limited to the blur correction device 7 having the above-described configuration including the heat transfer sheet 26, 26A, or 26B, and can be applied to various blur correction devices having a configuration in which the movable body is rotated in the direction around the optical axis (roll direction) with respect to the fixed body.

In the imaging device 1, at the time of blur correction of the blur correction device 7, the movable body 9 is moved in the upper-lower and left-right directions with respect to the fixed body 8, and the movable body 9 is rotated in the direction around the optical axis with respect to the fixed body 8. At this time, when the movable body 9 is at a reference position (a position indicated by a one-dot chain line in FIG. 9) where the movable body 9 is not rotated in the direction around the optical axis, assuming that distances between the restricting portions (first restricting portion 14, second restricting portion 15, third restricting portion 16, or fourth restricting portion 17) and an outer periphery of the movable body 9 are rotation allowable distances L, it is necessary to increase the rotation allowable distances L (rotation allowable distances L1, L2, L3, and L4) in four directions of upper-lower and left-right directions in order to cope with a large camera shake. The rotation allowable distances L in the four directions are increased, and thus, a rotatable angle of the movable body 9 with respect to the fixed body 8 in the direction around the optical axis increases. As a result, it is possible to cope with a large camera shake and to improve image quality. On the other hand, the imaging device 1 becomes large.

Therefore, the blur correction device 7 has the following configuration.

As described above, in the blur correction device 7, since the first coil attachment portion 21b and the second coil attachment portion 21c, which are disposition spaces of the first coil 22 and the second coil 23, are present in the movable body 9, a center Mp (optical axis P) of the imaging element 19 does not coincide with a center Mt of the entire movable body 9 and is positioned at the upper right of the center Mt. Furthermore, the fixed body 8 and the movable body 9 are formed in a horizontally long substantially rectangular shape.

In such a state, when the movable body 9 is rotated in one direction S1 in a direction around the optical axis P with respect to the fixed body 8 at the time of blur correction, for example, any of corner portions C1, C2, C3, and C4 of the movable body 9 comes into contact with the first restricting portion 14, the second restricting portion 15, the third restricting portion 16, and the fourth restricting portion 17, and thus, the rotation in the direction S1 is restricted.

At this time, assuming that the rotation allowable distances L are the same in the upper-lower and left-right directions, since the center Mp is positioned at the upper right of the center Mt and the fixed body 8 and the movable body 9 are formed in a horizontally long shape, the corner portions C2, C3, and C4 are brought into a state of not coming into contacting the second restricting portion 15, the third restricting portion 16, and the fourth restricting portion 17 in a state where the corner portion C1 comes into contact with the first restricting portion 14 (see an upper diagram of FIG. 9). Accordingly, an allowable degree of rotation in the direction S1 is determined by the upper rotation allowable distance L1.

Since the allowable degree of rotation in the direction S1 is determined by the upper rotation allowable distance L1 in this manner, in the blur correction device 7, the rotation allowable distance L1 is set to be larger than the rotation allowable distances L2, L3, and L4, and the rotation allowable distance L2, the rotation allowable distance L3, and the rotation allowable distance L4 are set to be the same (see a lower diagram of FIG. 9). Note that, the rotation allowable distance L2 and the rotation allowable distance L4 are desirably the same, but the rotation allowable distance L3 may be longer or shorter than the rotation allowable distances L2 and L4.

The rotation allowable distance L1 is set to be larger than the rotation allowable distances L2, L3, and L4 and the rotation allowable distance L2, the rotation allowable distance L3, and the rotation allowable distance L4 are set to be the same. Thus, it is possible to increase the rotatable angle of the movable body 9 with respect to the fixed body 8 in the direction around the optical axis while setting the size of the fixed body 8 to be a minimum necessary size.

As described above, in the blur correction device 7, the center Mt of the movable body 9 and the center Mp of the imaging element 19 do not coincide with each other, and one rotation allowable distance is set to be larger than the other rotation allowable distances.

Accordingly, only a direction in which the rotation allowable distance increased with respect to the other rotation allowable distances is present in a direction orthogonal to the optical axis P increases, and a rotation amount of the movable body 9 can be increased by setting the size of the fixed body 8 to the minimum necessary size, and the rotation amount of the movable body 9 can be increased while the reduction in size is secured.

Note that, although the example for the direction S1 has been described above, in a case where the rotation amount of the movable body 9 is increased in a direction S2 opposite to the direction S1, the rotation allowable distance L3 is only required to be set to be larger than the rotation allowable distances L1, L2, and L4 for a reason similar to the reason described above. Furthermore, in order to increase the rotation amount of the movable body 9 in both the directions S1 and S2, the rotation allowable distance L1 may be set to be larger than the rotation allowable distance L2, and the rotation allowable distance L3 may be set to be larger than the rotation allowable distance L4.

### One Embodiment of Imaging Device

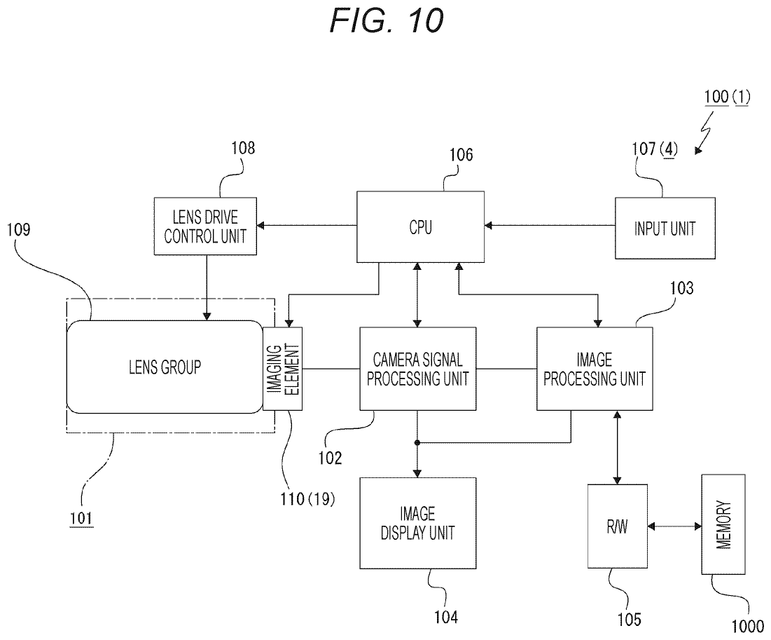

FIG. 10 illustrates a block diagram of a still camera according to the embodiment of the imaging device of the present technology.

An imaging device (still camera) 100 (corresponding to the imaging device 1) includes a lens unit 101 having an imaging function, a camera signal processing unit 102 that performs signal processing such as analog-digital conversion of an imaged image signal, and an image processing unit 103 that performs recording and reproducing processing of an image signal.

Furthermore, the imaging device 100 includes an image display unit 104 such as a liquid crystal panel that displays an imaged image and the like, a reader/writer (R/W) 105 that writes and reads an image signal to and from a memory 1000, a central processing unit (CPU) 106 that controls the entire imaging device 100, an input unit 107 (corresponding to the operation unit 4) including various switches and the like on which a user performs a required operation, and a lens drive control unit 108 that controls drive of a lens disposed in the lens unit 101.

The lens unit 101 includes an optical system including a lens group 109, an imaging element 110 (corresponding to the imaging element 19) such as a charge coupled device (CCD) or a complementary metal-oxide semiconductor (CMOS), and the like.

The camera signal processing unit 102 performs various types of signal processing such as conversion into a digital signal, noise removal, image quality correction, and conversion into a luminance and chrominance signal on an output signal from the imaging element 110.

The image processing unit 103 performs compression encoding and expansion decoding processing of an image signal based on a predetermined image data format, conversion processing of a data specification such as resolution, and the like.

The image display unit 104 has a function of displaying various type of data such as an operation state of the user on the input unit 107 and an imaged image.

The R/W 105 writes image data encoded by the image processing unit 103 into the memory 1000 and reads image data recorded in the memory 1000.

The CPU 106 functions as a control processing unit that controls each circuit block provided in the imaging device 100, and controls each circuit block on the basis of an instruction input signal and the like from the input unit 107.

The input unit 107 includes, for example, a shutter release button for performing a shutter operation, a selection switch for selecting an operation mode, and the like, and outputs an instruction input signal corresponding to an operation by the user to the CPU 106.

The lens drive control unit 108 controls a motor (not illustrated) and the like that drive each lens of the lens group 109 on the basis of a control signal from the CPU 106.

The memory 1000 is, for example, a semiconductor memory (memory card) detachable from a slot connected to the R/W 105 or an internal memory disposed inside the imaging device 100.

The operation in the imaging device 100 is hereinafter described.

In a standby state of imaging, under the control of the CPU 106, an image signal imaged by the lens unit 101 is output to the image display unit 104 via the camera signal processing unit 102 and is displayed as a camera-through image. Furthermore, when an instruction input signal for zooming is input from the input unit 107, the CPU 106 outputs a control signal to the lens drive control unit 108, and a predetermined lens of the lens group 109 is moved on the basis of the control of the lens drive control unit 108.

When a shutter (not illustrated) of the lens unit 101 is operated by an instruction input signal from the input unit 107, an imaged image signal is output from the camera signal processing unit 102 to the image processing unit 103, is subjected to compression encoding processing, and is converted into digital data in a predetermined data format. The converted data is output to the R/W 105 and is written to the memory 1000.

Focusing and zooming are performed by the lens drive control unit 108 moving a predetermined lens of the lens group 109 on the basis of a control signal from the CPU 106.

In a case where the image data recorded in the memory 1000 is reproduced, predetermined image data is read from the memory 1000 by the R/W 105 in accordance with an operation on the input unit 107, and the image processing unit 103 performs decompression decoding processing, and then a reproduced image signal is output to the image display unit 104 to display a reproduced image.

Note that, in the present technology, “imaging” refers to processing including only a part or all of a series of processing from photoelectric conversion processing of converting light captured by the imaging element 110 into an electrical signal to processing of converting an output signal from the imaging element 110 into a digital signal, noise removal, image quality correction, conversion into a luminance and chrominance signal, and the like by the camera signal processing unit 102, compression encoding and decompression decoding processing of an image signal based on a predetermined image data format by the image processing unit 103, conversion processing of a data specification such as resolution, and writing processing of an image signal into the memory 1000 by the R/W 105.

That is, “imaging” may refer to only photoelectric conversion processing of converting light captured by the imaging element 110 into an electrical signal, or may refer to processing from photoelectric conversion processing of converting light captured by the imaging element 110 into an electrical signal to processing of converting an output signal from the imaging element 110 into a digital signal, noise removal, image quality correction, and conversion into a luminance and chrominance signal, and the like by the camera signal processing unit 102, or may refer to processing from photoelectric conversion processing of converting light captured by the imaging element 110 into an electrical signal to compression encoding and decompression decoding processing of an image signal based on a predetermined image data format by the image processing unit 103, conversion processing of a data specification such as resolution via processing of converting an output signal from the imaging element 110 into a digital signal, noise removal, image quality correction, and conversion into a luminance and chrominance signal, and the like by the camera signal processing unit 102, may refer to processing from photoelectric conversion processing of converting light captured by the imaging element 110 into an electrical signal to processing of converting an output signal from the imaging element 110 into a digital signal, noise removal, image quality correction, and conversion into a luminance and chrominance signal, and the like by the camera signal processing unit 102, compression encoding and decompression decoding processing of an image signal based on a predetermined image data format by the image processing unit 103, conversion processing of a data specification such as resolution, and may refer to writing processing of an image signal into the memory 1000 by the R/W 105. In the above-described processing, the order of the processing may be changed as appropriate.

Furthermore, in the present technology, the imaging device 100 may include only a part or all of the imaging element 110, the camera signal processing unit 102, the image processing unit 103, and the R/W 105 that perform the above-described processing.

### Present Technology

The present technology can have the following configurations.
(1)

A blur correction device including
a fixed body fixed inside a housing,
a movable body having an imaging element and moved in a direction orthogonal to an optical axis direction with respect to the fixed body, and
an elastically deformable heat transfer sheet provided as a first close contact portion partially in close contact with the movable body in a state of being in surface contact with the movable body and a second close contact portion partially in close contact with the housing in a state of being in surface contact with the housing, in which
a third close contact portion in close contact with the fixed body in a state of being in surface contact with the fixed body is provided between the first close contact portion and the second close contact portion of the heat transfer sheet, and in the heat transfer sheet, a first bent portion is provided between the first close contact portion and the third close contact portion, and a second bent portion is provided between the third close contact portion and the second close contact portion.
(2)

The blur correction device according to the above (1), in which
an elastic body is disposed between the second close contact portion and the third close contact portion, and
the second close contact portion is pressed against the housing and the third close contact portion is pressed against the fixed body by elasticity of the elastic body.
(3)

The blur correction device according to the above (2), in which the elastic body includes a material having thermal conductivity.
(4)

The blur correction device according to any one of the above (1) to the above (3), in which
a portion between the housing and the fixed body in the heat transfer sheet is formed in an annular shape.
(5)

The blur correction device according to any one of the above (1) to the above (3), in which
a plurality of the second close contact portions are provided, and
the plurality of second close contact portions are in close contact with different portions of the housing, respectively.
(6)

The blur correction device according to any one of the above (1) to the above (3), in which a graphite sheet is used as the heat transfer sheet.
(7)

The blur correction device according to any one of the above (1) to the above (3), in which
a center of the movable body and a center of the imaging element do not coincide with each other,
the movable body is set to be rotatable in a direction around an optical axis with respect to the fixed body,
a plurality of restricting portions that restrict the rotation of the movable body in the direction around the optical axis are provided in the fixed body, and
when distances between the plurality of restricting portions and an outer periphery of the movable body in a state where the movable body is not rotated in the direction around the optical axis with respect to the fixed body are defined as rotation allowable distances, at least one rotation allowable distance is set to be larger than the other rotation allowable distances.
(8)

An imaging device including
a blur correction device in which a movable body having an imaging element is movable in a direction orthogonal to an optical axis direction with respect to a fixed body fixed inside a housing, in which
the blur correction device includes
an elastically deformable heat transfer sheet provided as a first close contact portion partially in close contact with the movable body in a state of being in surface contact with the movable body and a second close contact portion partially in close contact with the housing in a state of being in surface contact with the housing,
a third close contact portion in close contact with the fixed body in a state of being in surface contact with the fixed body is provided between the first close contact portion and the second close contact portion of the heat transfer sheet, and
in the heat transfer sheet, a first bent portion is provided between the first close contact portion and the third close contact portion, and a second bent portion is provided between the third close contact portion and the second close contact portion.

### REFERENCE SIGNS LIST

1 Imaging device
3 Housing
7 Image blur correction device
8 Fixed body
9 Movable body
14 First restricting portion
15 Second restricting portion
16 Third restricting portion
17 Fourth restricting portion
19 Imaging element
26 Heat transfer sheet
26a First close contact portion
26b Second close contact portion
26c Third close contact portion
26d First bent portion
26e Second bent portion
27 Elastic body
29 Elastic body
26A Heat transfer sheet
26B Heat transfer sheet
30 Elastic body
100 Imaging device
110 Imaging element

1. A blur correction device comprising:
a fixed body fixed inside a housing;
a movable body having an imaging element and moved in a direction orthogonal to an optical axis direction with respect to the fixed body; and
an elastically deformable heat transfer sheet provided as a first close contact portion partially in close contact with the movable body in a state of being in surface contact with the movable body and a second close contact portion partially in close contact with the housing in a state of being in surface contact with the housing, wherein
a third close contact portion in close contact with the fixed body in a state of being in surface contact with the fixed body is provided between the first close contact portion and the second close contact portion of the heat transfer sheet, and
in the heat transfer sheet, a first bent portion is provided between the first close contact portion and the third close contact portion, and a second bent portion is provided between the third close contact portion and the second close contact portion.

2. The blur correction device according to claim 1, wherein
an elastic body is disposed between the second close contact portion and the third close contact portion, and
the second close contact portion is pressed against the housing and the third close contact portion is pressed against the fixed body by elasticity of the elastic body.

3. The blur correction device according to claim 2, wherein
the elastic body includes a material having thermal conductivity.

4. The blur correction device according to claim 1, wherein
a portion between the housing and the fixed body in the heat transfer sheet is formed in an annular shape.

5. The blur correction device according to claim 1, wherein
a plurality of the second close contact portions are provided, and
the plurality of second close contact portions are in close contact with different portions of the housing, respectively.

6. The blur correction device according to claim 1, wherein
a graphite sheet is used as the heat transfer sheet.

7. The blur correction device according to claim 1, wherein
a center of the movable body and a center of the imaging element do not coincide with each other,
the movable body is set to be rotatable in a direction around an optical axis with respect to the fixed body,
a plurality of restricting portions that restrict the rotation of the movable body in the direction around the optical axis are provided in the fixed body, and
when distances between the plurality of restricting portions and an outer periphery of the movable body in a state where the movable body is not rotated in the direction around the optical axis with respect to the fixed body are defined as rotation allowable distances, at least one rotation allowable distance is set to be larger than the other rotation allowable distances.

8. An imaging device comprising:
a blur correction device in which a movable body having an imaging element is movable in a direction orthogonal to an optical axis direction with respect to a fixed body fixed inside a housing, wherein
the blur correction device includes
an elastically deformable heat transfer sheet provided as a first close contact portion partially in close contact with the movable body in a state of being in surface contact with the movable body and a second close contact portion partially in close contact with the housing in a state of being in surface contact with the housing,
a third close contact portion in close contact with the fixed body in a state of being in surface contact with the fixed body is provided between the first close contact portion and the second close contact portion of the heat transfer sheet, and
in the heat transfer sheet, a first bent portion is provided between the first close contact portion and the third close contact portion, and a second bent portion is provided between the third close contact portion and the second close contact portion.
